(19) United States
(12) Patent Application Publication
(10) Pub. No.: US 2003/0204460 A1
(43) Pub. Date: Oct. 30, 2003

(54) Data collection and transaction initiation using a financial messaging protocol

(76) Inventors: Rodney Robinson, Los Altos, CA (US); Stephen Zorn, Campbell, CA (US)

Correspondence Address: Benedict O'Mahoney, 1800 Embarcadero Road, Palo Alto, CA, 94303, US

(21) Appl. No.: 10/392,993

(22) Filed: Mar. 19, 2003

Related U.S. Application Data
(60) Provisional application No. 60/376,198, filed on Apr. 30, 2002.

(51) Int. Cl. G06F 17/60

(52) U.S. Cl. 705/35

(57) ABSTRACT

Financial Data Collector System that accepts a request from a financial messaging protocol server for financial account information, utilizes HTML Web page parsing to access a consumer's online financial account information from an Internet Web site, and returns the information in a message response. This system utilizes HTML parsing technology to emulate a consumer accessing online financial account information. Relevant data is parsed from the captured Web pages and download files, normalized, and returned in a formatted message response to the requester. This system provides a flexible, low cost, and quick to market implementation over existing solutions.

### CROSS-REFERENCE TO RELATION APPLICATIONS

This application claims the benefit of PPA Ser. No. 60/376,198, filed Apr. 30, 2002 by the present inventors.

### FEDERALLY SPONSORED RESEARCH

Not applicable

### SEQUENCE LISTING OR PROGRAM

Object code listing on appendix CD

### BACKGROUND OF INVENTION

1. Field of Invention

The present invention relates to the exchange of financial information over the Internet.

2. Prior Art

Personal Financial Manager (PFM) applications have become popular over the past eight years as a way for individuals to personally manage their finances from the convenience of their personal computer. PFMs can include basic banking features, scenario planning features, bill payment features, investment management features, and tax management features. Basic banking features allow consumers to view account information pertaining to deposit accounts, loans, or investments. Scenario planning features allow consumers to run scenario planners for retirement, education, home purchase, or debt reduction. Bill payment features include the ability to retrieve, view, and pay bills online. Investment management features include the ability to analyze investments, create and print detailed financial reports and statements. Tax management features include the ability to prepare tax returns. Examples of commercially available PFMs include Intuit's Quicken™, Intuit's Quickbooks™, and Microsoft's Money™.

A PFM is described in U.S. Pat. No. 881, which describes a software product running on users personal computer, displaying balances and transactions. Also presenting a single interface for bill payment and transfer of funds.

PFM applications are resident, and execute locally, on the consumer's own personal computer system. The consumer must enter his or her own financial profile, which may include information about financial deposits, investments, loan accounts, and personal assets and liabilities. The process of keeping one or more financial profiles up to date through hand entry of every transactions, credit or fee, is tedious and prone to errors due to erroneous, duplicate, or missed entries. The process of obtaining up to date and accurate information is often times cumbersome and further reduces the likelihood that the consumer can accurately keep their financial portfolio information current and correct.

To facilitate the electronic entering of financial data over the time intensive manual keystroke entry process prone to errors, many financial institutions provide an electronic to PFMs. The most popular method to transfer financial data to a PFM running on the consumer's own computer is through a file download from an Internet Banking application. Most PFM connected financial institutions employ this method of transferring balance, transaction, and investment information into the PFM. These file downloads are in QIF or OFX format, and are somewhat limited in the account types or richness of account information that can be transferred.

U.S. Pat. No. 5,884,312 describes a method for logging onto server and gaining secure access and requesting data from the server. U.S. Pat. No. 5,842,211 further describes the method for downloading the financial data from the financial institution into the PFM.

While much more efficient than hand keying in transactions and investments, file downloads are not without limitations and restrictions. File downloads will only transfer transactions into a PFM. Updates made in the PFM are not returned or reflected at the financial institution. Furthermore, the consumer must initiate and login to an online session with the financial application, navigate to the appropriate web page, and select the download function. Most financial institutions further encumber this process by permitting only one account to download at a time. Finally the user must carefully manage the date range of the downloaded transactions to insure that all transactions are downloaded without gaps. Older formats, including QIF, also require consumers to manually remove duplicate transactions from their register that are caused by overlapping download dates.

To overcome limitations associated with file downloads, Intuit, Microsoft, and Checkfree collaborated in 1997 with Wells Fargo, Chase Manhattan Bank, CitiBank, Schwab Brokerage, and Fidelity Investments to develop a new specification to provide interactive two-way communications between PFM client applications and financial application servers. Their efforts yielded a new specification called Open Financial Exchange (OFX). OFX is broadly described as a specification designed to enable and synchronize the exchange of financial data and transaction requests between consumers and their financial institutions. Financial institutions include banks, credit unions, credit card processors, mutual fund companies, brokerages, 401K/403B plan providers, and bill payment providers. The OFX message set employs Extensible Markup Language (XML) to provide an infrastructure for transferring financial data including, but not limited to, bank account information and statements, credit card information and statements, stop check requests and status, intrabank and interbank funds transfer requests, returned item notifications, bill payments, bill presentments, investment account activity, investment positions, investment balances, open orders, account discovery of all active accounts, emails, and credential validations.

OFX defines a mechanism where a client submits a request for financial information and the server responds with status and for validated clients relevant financial account information. OFX Direct defines an implantation which supports the exchange of financial information to keep PFM account data synchronized with financial institution's Core Banking System. Using this feature, consumers can easily load their new or updated online account information from within their PFM session. A subset of these implementations provides additional functionality that includes email exchange and the ability to initiate transfer requests from a PFM. A smaller subset provides the capability to initiate and manage bill payment requests from a PFM.

The Interactive Financial exchange (IFX) Forum was formed in 1997 by leading financial institutions, service providers and independent software vendors to create a messaging standard for financial services that would address a more complete financial messaging data set than offered by OFX. It was based on work previously done by the Open Financial Exchange (OFX) and IBM/Integrion GOLD standard. While specifications have been published, few institutions have implemented servers to support IFX messaging and the leading PFM's do not currently support the format, nor have they publicly expressed intentions to do so.

The Financial Information eXchange (FIX) effort was initiated in 1992 by a group of institutions and brokers interested in streamlining their trading processes. FIX Protocol, Ltd. developed the FIX protocol as a messaging standard developed specifically for the real-time electronic exchange of securities transactions. FIX was originally defined for use in supporting US equity trading with message traffic flowing directly between principals. Over time, a number of fields were added to support cross-border trading, derivatives, fixed income, and other products. FIX has not currently been actively deployed on PFM applications.

Screen scraping technology first emerged in the early 1980's as a way to extract information from mainframe computers for use in client-server systems. Early terminal interfaces, such as IBM 3270 and 5250 formats, contained single characters occupying an (x,y) coordinate in a matrix structure of rows and columns. Screen scraping programs initially consisted of parsing programs that examined the matrix of characters on the screen for an anchor to identify the current screen, navigated to other screens through simulating keystroke selections of items on a menu, and read characters from pre-defined coordinate locations for relevant data.

Financial institutions today continue to employ similar screen scraping technologies to extract financial account information from their Core Banking Systems. Consumers login to Internet Banking applications and request to view their financial account information. Many Internet applications include a screen scraping application to access information directly from the Core Banking System's teller terminal interfaces. Relevant data is parsed and formatted before it is returned to the Internet Browser for display to the user. In this scenario the consumer's Internet Browser application acts as the client requesting financial account information from the Internet Banking application server. Other non-screen scraping methods commonly employed to access financial data from the Core Banking System include direct database access, file feeds, and various request/response methods to other applications.

Account aggregators extended the screen scraping model previously discussed to scrape financial and non-financial account data from HTML formatted Internet Web pages. The principle behind account aggregation is to permit consumers to access all of their accounts at one single location on the Internet using only one set of access credentials. Consumers register with the account aggregator, provide the names of their financial institutions or online services providers, with whom they have online accounts, as well their access credentials. The account aggregator securely stores the consumer's personal access credentials and uses them to access the consumer's various online accounts. The account aggregator will emulate the consumer's actions to login to the Internet online application using the consumer's provided credentials, extract the necessary financial account information, and deliver it back to the user on a single web page. Account aggregators will frequently repeat the process of accessing and extracting the consumer's financial account information on a daily basis and store the results in a local data warehouse for quick access on demand when the consumer signs on to the account aggregator's application to view his or her consolidated account information. Reporting, data mining, and other web-based client applications can also access and use the aggregated data from the data warehouse.

Account aggregators utilize institution access scripts that contain detailed instructions on how to access online applications, login, navigate pages, extract relevant data, normalize the data, and store it into a data structure. These scripts are designed to be quickly customized for each unique site and easily updated to accommodate frequent Internet web page changes to the online application.

Other implementations, such as described in U.S. Pat. No. 6,446,048 have used a central database to consolidate financial data from various sources and made them available to multiple client computers such as PFMs. However, they focus on synchronization as opposed to a quick to market, low cost, easy to install method for extracting a users financial account data and making it available to a client application such as a PFM.

### OBJECTS AND ADVANTAGES

Current OFX Direct implementations as of this claim date, utilize custom built applications and often proprietary methods to access the financial account data in the same manner as Internet Banking applications previously described. Development of the OFX Direct implementation requires connecting the OFX server, typically previously certified with Intuit and Microsoft, to the custom application. In-house testing and certification testing of the custom application is typically an intensive process lasting several weeks as dozens of well defined test case scripts are executed to validate the system. Security issues of connecting another Internet Web Server through the firewall to secure back-office systems further complicates and slows down the implementation and testing process.

### SUMMARY

The present invention uses screen scraping to access financial account data over existing Internet channels and return the requested data in a formatted response to the requesting client application, which in the most common embodiment includes a personal financial manager client.

The preferred embodiment of this invention includes a personal financial manager application connected to a financial messaging protocol server that services requests for information as well as permits consumers to make transaction requests such as transfers, bill payments, and emails. The current systems require extensive customization and testing to install in a financial institution. Our invention combines screen scraping technologies with the financial messaging protocol server to create a new system that accesses financial data through publicly available external channels such as the Internet. The claimed system will process requests from client for financial account data by accessing the online account application using credentials supplied by the consumer and parsing relevant fields for required data.

### DRAWINGS

### FIGURES

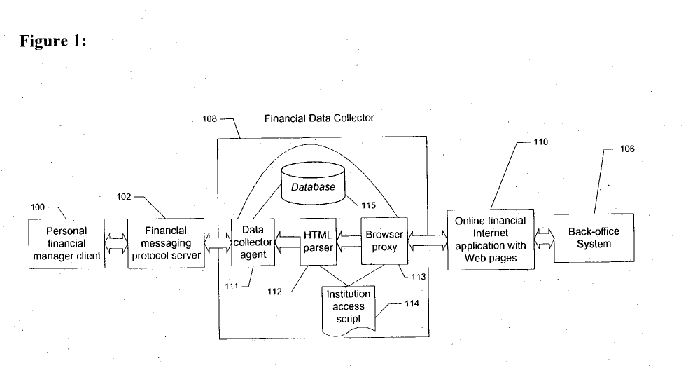

FIG. 1 illustrates the system components

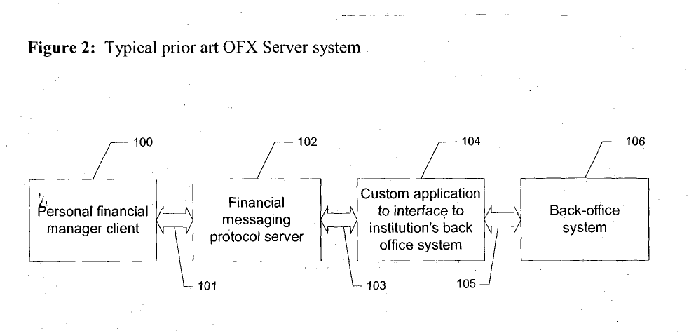

FIG. 2 illustrates a typical prior art OFX Server system that has been implemented by various vendors in over 200 institutions.

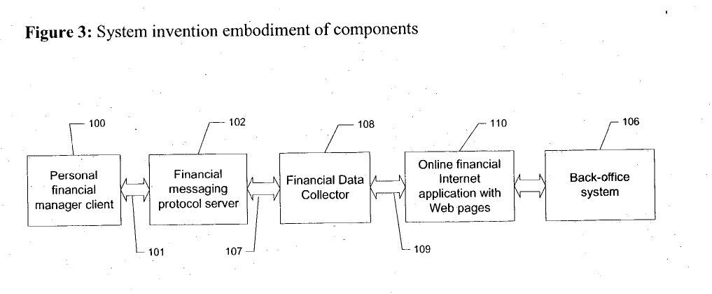

FIG. 3 illustrates the embodiment of components of the presently claimed system.

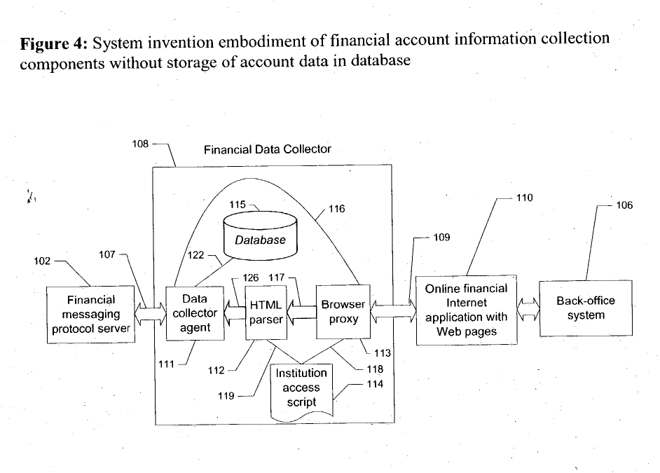

FIG. 4 illustrates a detailed embodiment of components of the presently claimed system without storage of account data in database

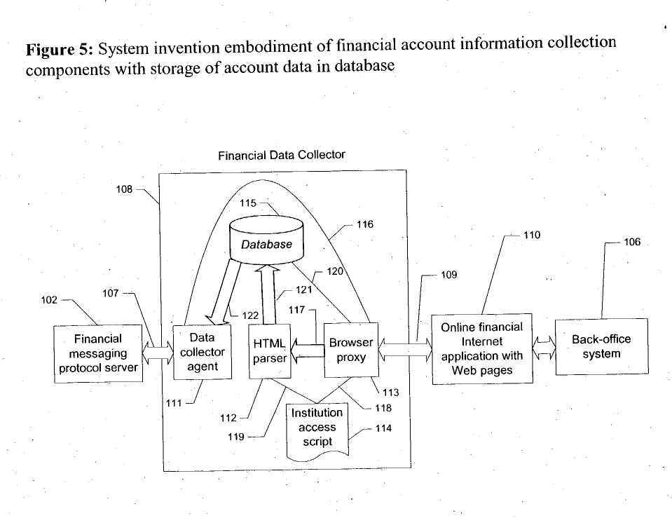

FIG. 5 illustrates a detailed embodiment of components of the presently claimed system with storage of account data in database

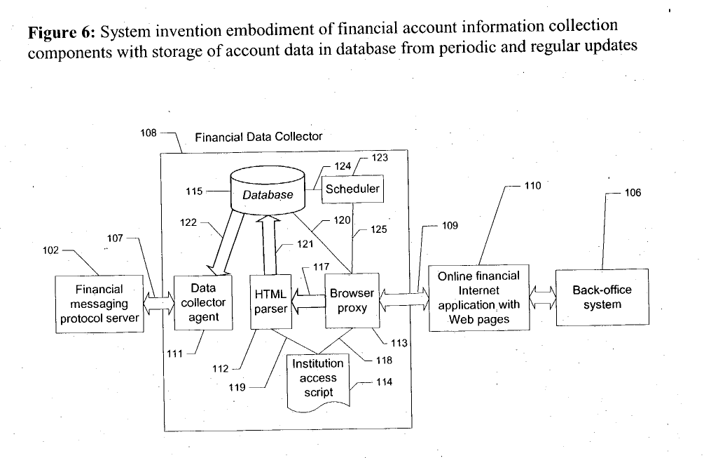

FIG. 6 illustrates a detailed embodiment of components of the presently claimed system with storage of account data in database

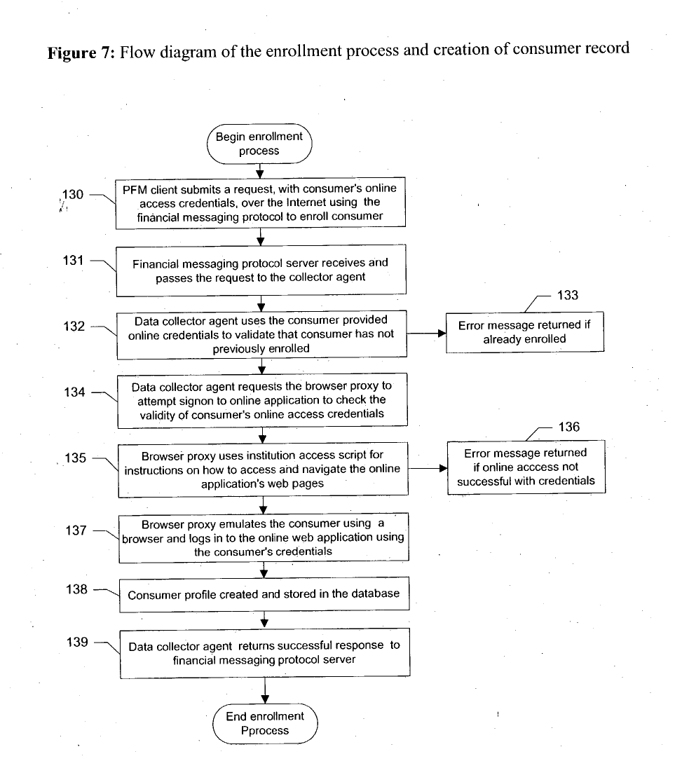

FIG. 7 illustrates the process flow diagram of the enrollment process used to add a new user to the system according to one embodiment of the presently claimed invention

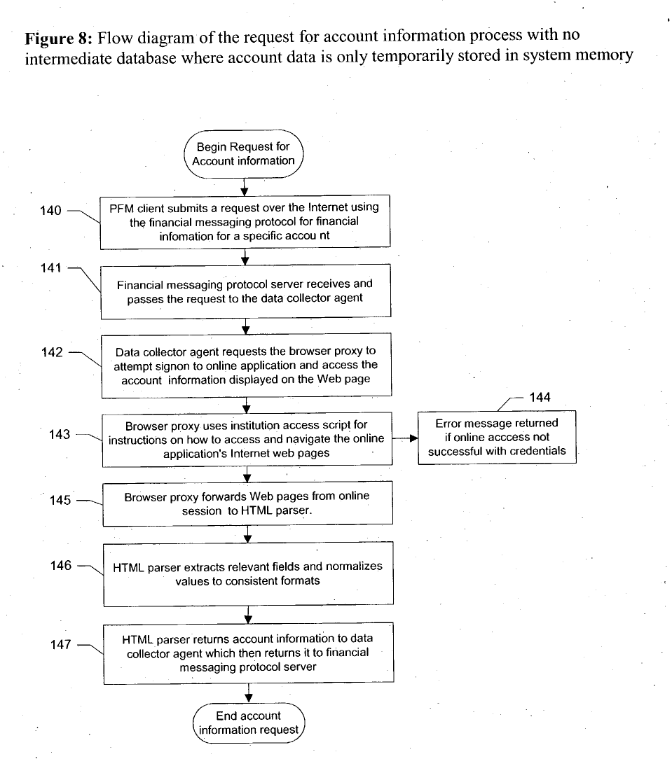

FIG. 8 illustrates the process flow diagram of the request for account information process with no intermediate database according to one embodiment of the presently claimed invention.

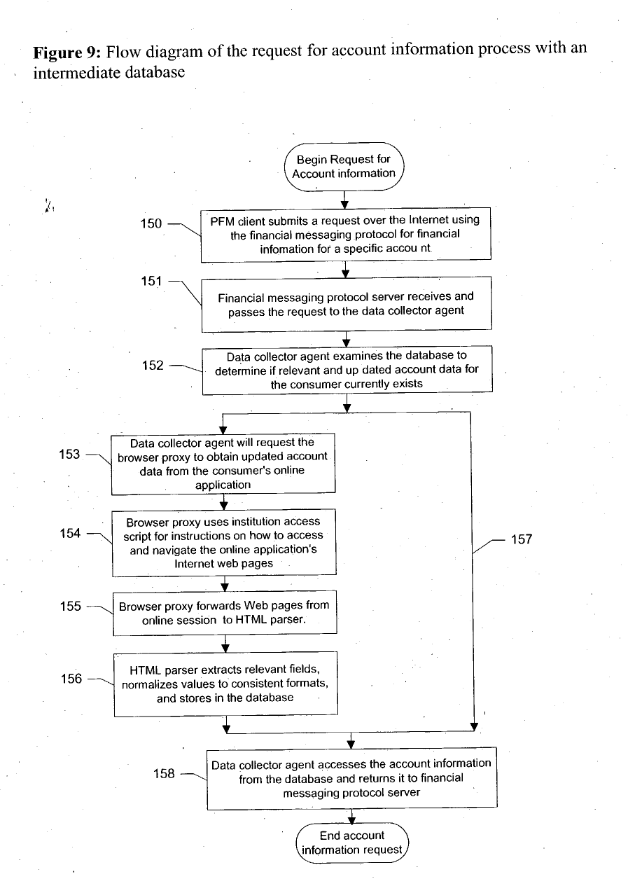

FIG. 9 illustrates the process flow diagram of the request for account information process with an intermediate database according to one embodiment of the presently claimed invention.

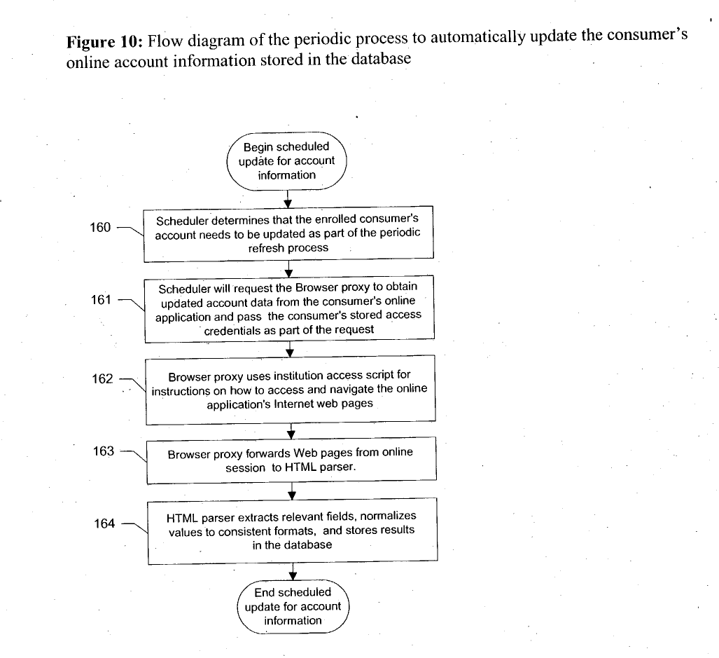

FIG. 10 illustrates the process flow diagram to automatically update, on a regularly scheduled basis, the consumer's online account information stored in the database.

### REFERENCE NUMERALS

100—Personal financial manager client

101—Internet based financial messaging protocol formatted interface between personal financial manager client and financial messaging protocol server

102—Financial messaging protocol server

103—Interface from the financial messaging protocol server to proprietary custom application that interfaces to the Back-office system

104—Proprietary custom application that interfaces to the back-office system

105—Interface that proprietary custom application uses to extract financial data from the back-office system

106—The back-office system that contains the consumer's financial account information

107—The interface between the financial messaging protocol server and the Financial Data Collector

108—The Financial Data Collector, otherwise referred to as the claimed invention

109—The http or https interface between the Financial Data Collector and the online financial application's Web pages

110—The online financial application that consists of a set of navigable HTML Web pages inside a secure and authenticated session normally accessible by the consumer through an Internet browser

111—The data collector agent, a part of the invention that receives, processes, and responds to requests from the financial messaging protocol server

112—The HTML parser, a part of the invention, that parses valid data from a Web page, normalizes the values, and either stores the data in the database or forwards the data to the data collector agent or both stores and forwards the data.

113—The browser proxy, a part of the invention, that utilizes instructions in the institution access script to emulate the consumer using a browser to access his/her online account information through establishing a secure and authenticated Web session with the online financial Internet application, navigating the Web pages, and capturing Web pages that contain valid data.

114—The institution access script, a part of the invention, that contains specific instructions on how to access the target online financial Internet application, how to login to the secure session, how to navigate the pages in the online application, how to parse valid data from Web pages, how to normalize valid data, and how to store the data in a database.

115—The database, a part of the invention, that contains consumer profile information, the consumer's online financial Internet application's access credentials, in encrypted format, account information, and logs.

116—The interface through which the data collector agent initiates a request to the browser proxy to collect financial account information on behalf of the specified client

117—The interface through which the browser proxy returns HTML pages to the HTML parser

118—The interface through which the browser proxy requests and receives instructions from the institution access script on how to access and navigate the online financial Internet application's Web pages

119—The interface through which the HTML parser requests and receives instructions from the institution access script on how to parse and normalize data fields from the Web pages

120—The interface through which the browser proxy requests and receives the consumer's online access credentials

121—The interface through which the HTML parser writes account data and status to the database

122—The interface through which the data collector agent queries and writes to the database

123—The scheduler that schedules periodic updates of the consumer's financial account information to make timely account data available in the database

124—The interface whereby the scheduler requests and keep track of necessary updates from the database

125—The interface whereby the scheduler initiates a request to the browser proxy to access the consumer's online account information

126—The interface whereby the HTML parser returns account data to the data collector agent

130—Step 1 of the consumer enrollment process

131—Step 2 of the consumer enrollment process

132—Step 3 of the consumer enrollment process

133—Error step if consumer is already enrolled

134—Step 4 of the consumer enrollment process

135—Step 5 of the consumer enrollment process

136—Error step if consumer's credentials are not validated correctly

137—Step 6 of the consumer enrollment process

138—Step 7 of the consumer enrollment process

139—Step 8 of the consumer enrollment process

140—Step 1 of the request for consumer account information process with no intermediate database

141—Step 2 of the request for consumer account information process with no intermediate database

142—Step 3 of the request for consumer account information process with no intermediate database

143—Step 4 of the request for consumer account information process with no intermediate database

144—Error step if invalid credentials used to access consumer account information with no intermediate database

145—Step 5 of the request for consumer account information process with no intermediate database

146—Step 6 of the request for consumer account information process with no intermediate database

147—Step 7 of the request for consumer account information process with no intermediate database

150—Step 1 of the request for consumer account information process with an intermediate database

151—Step 2 of the request for consumer account information process with an intermediate database

152—Step 3 of the request for consumer account information process with an intermediate database

153—Step 4 of the request for consumer account information process with an intermediate database when data needs to be updated

154—Step 5 of the request for consumer account information process with an intermediate database when data needs to be updated

155—Step 6 of the request for consumer account information process with an intermediate database when data needs to be updated

156—Step 7 of the request for consumer account information process with an intermediate database when data needs to be updated

157—Path when account data in database is relevant and up to date

158—Last step where data collector agent extracts account data from the database as part of the request for consumer account information and returns the result to the requester

160—Step 1 of the process to automatically update, on a regular schedule, the consumer's account-information

161—Step 2 of the process to automatically update, on a regular schedule, the consumer's account information

162—Step 3 of the process to automatically update, on a regular schedule, the consumer's account information

163—Step 4 of the process to automatically update, on a regular schedule, the consumer's account information

164—Step 5 of the process to automatically update, on a regular schedule, the consumer's account information

### DETAILED DESCRIPTION—FIGS. 1A AND 1B—PREFERRED EMBODIMENT

The present invention relates to a system used to collect financial information through an existing Internet Web channel in servicing a request from a client application. In the following detailed description, numerous specific details are set forth in order to provide a more thorough understanding of the present invention. It will be apparent to one of ordinary skill in the art, that these specific details need not be used to practice the present invention. In other instances, well known structures, interfaces, and processes have not been shown in detail in other to not obscure the present invention.

FIG. 1 illustrates a system where Personal Financial Manager client application 100, typically represented as either Intuit's Quicken™ or Quickbooks™, or Microsoft's Money™, makes a request for financial information from an institution. The Financial Messaging Protocol Server 102 receives and parses the request. The system invention, represented as the Financial Data Collector 108, accepts a request for financial account data from the Financial Messaging Protocol Server 102. The Financial Data Collector 108 will check if it has stored the relevant data in its local database 115 or if it needs to make a request for account data from the Online Financial Internet Application 110. If the Financial Data Collector 108 determines that it needs to collect account data from the Online Financial Internet Application 110, it will request the Browser Proxy 113 to emulate the consumer and login to the consumer's Web based financial application using the consumer's access credentials. The Online Financial Internet Application 110, previously connected to the Core Banking System 106 contains the consumer's financial account data. The HTML Parser 112 will parse and normalize the pages and return the results to either the Database 115 or the Web Agent 111. The Financial Data Collector 108 will then return a response with the relevant account data to the Financial Messaging Protocol Server 102 requester. The Financial Messaging Protocol Server 102 will subsequently return the results to the calling client.

FIG. 2 illustrates a typical system in which a personal financial manager client application, typically represented as either Intuit's Quicken™or Quickbooks™, or Microsoft's Money™, makes a request for financial information from an institution. The preferred embodiment of the present invention is implemented using an OFX Server to handle a secure two-way request/response interchange between the client and server across the Internet using the OFX protocol. Custom code is written to interface directly to the accounting system to extract account information.

In general, such systems involve a client 100 running on the consumer's personal computer and connected to the Internet 101. The consumer will initiate a request for financial account information using the Internet 101 to send the request using a financial messaging protocol typically encrypted with an encryption protocol such as Secure Sockets Layer SSL. The Financial Messaging Protocol Server 102 will receive the request from the Internet 101 and parse the request. The results are passed through a proprietary interface 103 to an application 104 which was custom developed to service this type of request. The custom application 104 will parse the request and extract the relevant financial information from a Core Banking System 106 through a proprietary interface 105. The custom application 104 will return the response to the Financial Messaging Protocol Server 102, which formats and returns the request over the Internet 101 to the requesting client 100.

Personal Financial Manager Clients 100 consist of applications for managing personal expenses from a personal computer. The most common applications as of this date are Intuit's Quicken™ and Quickbooks™, and Microsoft's Money™. These applications support the OFX interface to enable secure, via SSL, two-way interactive messaging across the Internet 101 to a specific institution where the consumer has a relationship. While OFX formatted download files are frequently employed by hundreds of financial institutions as a means to download data from a web site within an online Internet web application, the messaging mechanism in this invention, of which OFX Direct is the preferred and most common embodiment, is a direct two-way request and response protocol that can also be used to make specific requests for data and/or transactions. These prior art implementations require custom applications to extract financial account information from a Core Banking System. Typical implementations require either custom coding to an application programming interface, a screen scrape of an internal host based application, online query access of a database, or parsing of files or feeds contain financial information. The challenge in implementing these prior art implementations lies in separate and largely mutually exclusive development, installation, and testing for every unique institution and thereby failing to capitalize on previous implementations to greatly reduce cost and time to market of new implementations. The security infrastructure for these prior art implementations must also be addressed and resolved when developing applications that access the consumer's private financial information.

FIG. 3 illustrates the embodiment of major components of the presently claimed system invention. In general, this system invention involves a financial application client 100 running on the consumer's personal computer and connected to the Internet 101. The consumer will initiate a request for financial account information using the Internet 101 to send the request using a financial messaging protocol. The Financial Messaging Protocol Server 102 will accept and parse the request from the Internet. The results are passed to a Financial Data Collector 108 which will use the consumer's credentials to access the Core Banking System 106 through the financial institution's existing Internet financial application 110 that the consumer typically uses to access personal account balances and transactions using an Internet Browser. The Financial Data Collector 108 emulates a consumer attempting to login to his/her online Internet application 110 and parses the web pages for specific financial account data associated with the consumer. The parsed account level data is returned by the Financial Data Collector 108 to the Financial Messaging Protocol Server 102 which reformats and returns the response to the calling client application 100 over the Internet 101.

The development and testing effort to implement a system whereby a financial manager client application requests account data for a consumer from a financial institution is greatly reduced through the use of previously deployed online applications available through the Internet. The embodiment of the presently claimed system invention enables a quick to market and low cost implementation with minimal programming effort. Most of the development effort lies in creation of a unique script to locate the site, navigate the online application's web pages, parse relevant data from the correct page locations, and normalize the values to type definitions. A script typically takes a few days to develop and test for most online application web sites. The embodiment of the presently claimed system invention also permits location independence since the interface 101 is through an Internet connection. Location independence permits easier testing from any location and final installation optionally outside the corporate firewall.

FIG. 4 illustrates a more detailed description of the embodiment of the claimed system invention without storage of consumer financial account information in a local database 115. The Financial Messaging Protocol Server 102 receives a request for account information, parses the relevant information from the request, and passes the request through either a local or network attached interface 107 to the Web Agent 111 component of the Financial Data Collector 108. The Web Agent 111 will access 122 the database 115 to validate prior enrollment and log the user accessing the service. For previously enrolled consumers, the Web Agent 111 passes a request with online access credentials, received as part of the request from the Financial Messaging Protocol Server 102, to the Browser Proxy 113 to initiate a Web session and attempt to login to the Online Financial Internet Application 110. The Browser Proxy 113 will emulate the consumer accessing their personal account information using a Web browser attached to the Internet 109. The Browser Proxy 113 will access the instructions supplied by the Institution Access Script 114 to determine the Online Internet Financial Application's 110 login page URL, the manner to authenticate itself with the consumer's valid online access credentials, and the method to navigate the Web pages. The Browser Proxy 113 returns the online session's web pages to the HTML Parser 112. The HTML Parser 112 will use the parsing instructions contained in the Institution Access Script 114 to parse the valid data fields from the Web pages, normalize the values to consistent formats, and return 126 the result to the Web Agent 111. The Web Agent 111 will return status codes and valid data to the Financial Messaging Protocol Server 102 which will format and return a response to the requester client 100.

FIG. 5 illustrates a detailed description of the embodiment of the claimed system invention that stores account data in a local database. This embodiment uses a database 115 to store financial account data for the consumer. The data is updated in the database 115 from a prior online request for the consumer data. The consumer's online access credentials to the Online Financial Internet Application 110 are also stored in encrypted format in the database 115. The Financial Messaging Protocol Server 102 receives a request for account information, parses the relevant information from the request, and passes the request through either a local or network attached interface 107 to the Web Agent 111 component of the Financial Data Collector 108. The Web Agent 111 requests 122 the database 115 to check if a record for the consumer exists indicating prior enrollment. If a consumer record exists in the database 115, the Web Agent 111 will check if the relevant financial account data required to satisfy the request from the client exists in the database 115. If the account data exists, the Web Agent 115 will determine if the account data is recent. If recent, the Web Agent 111 will extract the requested data from the database 115 and return the response to the Financial Messaging Protocol Server 102. If the requested account data does not exist or is stale, the Web Agent 111 will initiate a request 116 to the Browser Proxy 113 to login to the Online Internet Financial Application 110. The Browser Proxy 113 will emulate the consumer accessing his/her personal account information using a Web browser attached to the Internet 109. The Browser Proxy 113 will extract 120 the consumer's online access credentials from the database 115 and access 118 the instructions supplied by the Institution Access Script 114 to determine the Online Internet Financial Application's 110 login page URL, the manner to authenticate itself with the consumer's valid online access credentials, and the method to navigate the application's Web pages 110. The Browser Proxy 113 returns 117 the session's web pages to the HTML Parser 112. The HTML Parser 112 will request 119 instructions from the Institution Access Script 114 to parse the valid data fields contained in the Web pages, normalize the values to consistent formats, and write 121 the results to the database 115. The Web Agent 111, upon detecting that the data collection process has completed, will extract 122 the relevant financial account data from the database 115 and return a response to the Financial Messaging Protocol Server 102 which will format the response for return to the originating client 100.

FIG. 6 illustrates a detailed description of the embodiment of the claimed system invention that stores account data collected from regularly scheduled periodic updates. Whereas FIG. 5 describes the update process as initiated by a request from the client, FIG. 6 describes another embodiment where a scheduler initiates the update process on a periodic, typically daily basis. The consumer's online access credentials to the Online Internet Financial Application 110 are also stored in encrypted format in the database 115. The Scheduler 123 will initiate requests to update the enrolled consumers' financial account data on a regularly scheduled recurring basis. A typical embodiment would employ a daily update of all available account information for all enrolled consumers. The Scheduler 123 will determine the enrolled consumer accounts that require updating and request 125 the Browser Proxy 113 to login to the Online Financial Internet Application 110. The Browser Proxy 113 will emulate the consumer accessing their personal account information using a Web browser. The Browser Proxy 113 will extract 120 and decrypt the consumer's online access credentials from the database 115 and access 118 the instructions supplied by the Institution Access Script 114 to determine the Online Financial Internet Application's 110 login page URL, the manner to authenticate itself with valid online access credentials, and the method to navigate the web site. The Browser Proxy 115 returns 117 the online session's web pages to the HTML Parser 112. The HTML Parser 112 will extract 119 and use the parsing instructions contained in the Institution Access Script 114 to parse the data from the Web page, normalize the values to consistent formats, and return 121 the results to the database 115. The Web Agent 111, upon receiving a request for consumer account data from the Financial Messaging Protocol Server 102, will request 122 the database 115 for account information, detect valid and current account data for the consumer exists, and return the results to the Financial Messaging Protocol Server 102 which will reformat the response for return to the originating client 100. A login to the Online Financial Internet Application 110 is not required in this case. The account data is updated on a periodic basis and is generally available to the requester without real-time access to the Online Financial Internet Application 110 thereby reducing the likelihood of a failed request due to a failed login to the consumer's account on the Online Financial Internet Application 110. Storage of the consumer's financial account data also reduces any delays in fulfilling the request from the Financial Messaging Protocol Server 102 since an immediate login and navigation of the Online Financial Internet Application 110 Web site is not required to respond to the request.

FIG. 7 illustrates a process flow diagram of the consumer enrollment process of the embodiment of the claimed system invention. All transactions are atomic in that they begin with a request and end with the related response. The process begins in processing block 130 with the consumer desiring to access their account information through their Personal Financial Manager Client. The consumer enters their personal information including online access credentials to the selected financial institution. In processing block 131 the Financial Messaging Protocol Server will receive the enrollment request, parse the relevant information, and pass the enrollment request information to the Web Agent 111. The Web Agent 111, in processing block 132 will first check the database 115 to validate that the consumer has not previously enrolled. If the consumer has previously enrolled, an error response is returned 133 to the requesting client application. In processing block 134 the Web Agent 111 will pass the consumer's online access credentials to the Browser Proxy 113 and request that the Browser Proxy 113 validate the credentials. The Browser Proxy 113, in processing block 135, will use the Institution Access Script 114 for the selected institution to access the online application's Internet 110 login page and attempt to login in the same manner as a consumer using an Internet browser. If the Browser Proxy 113 cannot successfully login to the online application, an error message 136 is returned to the requester. On a successful login, described by processing block 137, a consumer profile is created 138 and stored in the database 115. The Web Agent 111, in processing block 139, will return a successful enrollment response to the Financial Messaging Protocol Server 102 which will reformat and return the response to the originating client 100. An extension to the enrollment process described above will permit the client application to request a list of all valid accounts numbers and types accessible by the consumer from their authenticated Online Financial Internet Application 110. The list of account numbers and types, as parsed by the HTML Parser 112, is returned by the Web Agent 111 in a response to the calling application 100.

FIG. 8 illustrates a process flow diagram of the request for account information of the embodiment of the claimed system invention where no intermediate database is used to hold account data. Personal Financial Manager Client applications frequently provide the capability for the consumer to select and request account information for specific accounts. The claimed system invention provides the capability to access and return information on a specific account as sent in the request. The process begins in processing block 140 with the consumer submitting a request for account information on one or more of his/her assigned accounts through their Personal Financial Manager Client application 100. The request is received, as described in processing block 141, by the Financial Messaging Protocol Server 102 which parses the relevant information and passes the request to the Web Agent 111. The Web Agent 111, in processing block 142, parses the consumer's online access credentials and requests 116 the Browser Proxy 113 to login to the online application 110. As described in processing block 145, the Browser Proxy 113, will use the Institution Access Script 114 to locate the login page, login to the online financial application using the consumer's access credentials, navigate to the account information page, and return 117 the Web page to the HTML Parser 112 for parsing as described in processing blocks 143 and 145. If online access is not successful 144 or accounts could not be found, the appropriate error message will be returned to the requester 102. The HTML Parser 112, in processing block 146, will extract the relevant fields from the returned web pages and normalize values. The HTML Parser 112 will return the account data 126 to the Web Agent 111. The results are then returned by the Web Agent 111 to the Financial Protocol Messaging Server 102, as shown in processing block 147. The Financial Protocol Messaging Server 102 will format the response and return it to the originating client 100.

FIG. 9 illustrates a process flow diagram of the request for financial account information with an intermediate database holding financial account information representing another common embodiment of the claimed system invention. The process begins in processing block 150 with the consumer submitting a request to update financial account information on one or more of their assigned accounts through their Personal Financial Manager Client application 100. The request is received in processing block 151 by the Financial Messaging Protocol Server 102, which parses the relevant information and passes the request to the Web Agent 111. The Web Agent 11, in processing block 152, requests 122 account information from the database 115 and determines if the stored information is relevant and current. If relevant, processing path 157 is taken where the Web Agent 111 will return the stored information 158 to the requesting Financial Protocol Messaging Server 102 which will format the response and return it to the originating client 100. If the Web Agent, in processing step 152, determines that the locally stored account information is not relevant or up to date, it issues a request 116, as shown in processing block 153 to the Browser Proxy 113 to login to the Online Financial Internet Application 110. The Web Agent 111 passes the consumer's online access credentials to the Browser Proxy 113. In processing block 154, the browser proxy will use the Institution Access Script 114 to locate the login page, login to the Online Financial Internet Application 110, navigate to the account information page, and return the page for parsing 155. If online access is not successful or accounts could not be found, the appropriate error message will be returned to the requester. The HTML Parser 112, in processing block 156, will extract the relevant fields from the returned web pages and normalize values. The results are written 121 to the database 115, as described in processing block 156. Processing path 157 describes the step where the Web Agent 111 will return the stored information 158 from the database 115 to the requesting Financial Protocol Messaging Server 102 which will format the response and return it to the originating client 100.

FIG. 10 describes the optional process where the consumer's account information can be updated on a regularly scheduled basis, typically daily, and stored in the database 115 for later servicing a request for account information. The advantage of collecting financial data on a regular basis lies in faster servicing of a request for information, since accessing an Online Financial Internet Application 110 can take up to a minute or more to complete. Another advantage lies in the ability to service the request if the Online Financial Internet Application 110 is currently not available. The process to update the consumer's online account information typically is scheduled to start early in the morning after all account processing updates have occurred at the financial institution. The process begins in step 160 with the Scheduler 123 scanning all enrolled consumer profiles and preparing a list for updating. Requisite information that must be stored in the database 115 includes the consumer's online access credentials and account numbers. These are typically stored in the database 115 as part of the enrollment process. Updates to this stored information can occur when changes are detected in a new information request. In process step 171, the Scheduler 123 will request 125 the Browser Proxy 113 to login and navigate the consumer's Online Financial Internet Application 110 web site and return pages 117 to the HTML Parser 112. The HTML Parser 112, will parse relevant fields from the returned HTML pages, normalize data values, and store 121 the account data in the database 115. No action is required by the Web Agent 111 at this point since there is no active request from the Financial Messaging Protocol Server 102. At some later time, the Web Agent 111 can optionally access and use the stored account data from the database 115 to service the request for account information from the Financial Messaging Protocol Server 102.

What is claimed is:

1. A system for providing financial account information to a personal financial manager client utilizing the financial institution's existing online Internet application, comprising:
a. a Web Agent to communicate with a financial messaging protocol server;
b. a Browser Proxy application that emulates a consumer accessing their online financial application using Internet browser protocol methods;
c. an HTML Parser that parses the online financial application web pages, extracts specific information from fields, and normalize the field values to consistent formats;
d. an institution access script with instructions on how to access the online financial application web site, navigate the online financial application web pages, and locate specific fields with required information; and
e. a database that contains a consumer profile and can contain account information such as balance, transaction history, positions, open market orders, access credentials, and log information.

2. The system of claim 1, connecting to a financial messaging protocol server that accepts a formatted request from the personal financial manager client using a financial messaging protocol to download financial account information for a specific individual and returns a formatted response with the requested information to the personal financial manager client.

3. The system of claim 1 comprising an institution access script that contains specific instructions on how to access the online financial application information including:
a. how to locate the online financial application,
b. how to enter credentials to authenticate the browser proxy to the online financial application
c. how to navigate the online financial application's web pages within an authenticated session
d. location of specific financial data fields on the online financial application's web pages within an authenticated session
e. interpretation and translation of specific financial values within an online financial application's web pages into a normalized format
f. how to access, download, and parse formatted files, when available from the online financial application, containing the consumer's financial account data
g. specific actions to take when encountering errors in attempting to access financial data within the online financial application.

4. The system of claim 1 comprising a browser proxy with the ability to use the institution access script to initiate an Internet session over a secure https protocol, establish a connection to the online application's login page, use the consumer's online access credentials to login, navigate the online application emulating the consumer using an Internet browser, and return selected web pages and download files to the HTML Parser.

5. The system of claim 1 comprising an HTML parser with the ability to use the institution access script to parse selected Web pages or download files to extract required data, normalize the required data to a consistent type, and either store said data in a database or return said data to the Web Agent.

6. The system of claim 1 for providing financial account information comprising a method for enrollment of consumers into the service through a validation of the consumer by an attempt to login to the online application using the consumer's online access credentials that are supplied in the request message sent by the client.

7. A system for providing financial account information comprising a method for enrollment of consumers into the service through a validation of the consumer by an attempt to login to the online application using the consumer's online access credentials that are supplied in the request message sent by the client.

8. The enrollment method of claim 7 creating a database record for the consumer that has supplied valid access credentials to their online financial Internet application. The consumer database record containing, but not restricted to, some or all of the following consumer information:
a. Consumer's name
b. Consumer's address, contact, and personal information
c. Consumer's access credentials to their account information on the online financial Internet application
d. Log record of consumer activity

9. The system for providing financial account information comprising a method for servicing requests for account information and returning a response with the relevant data or an error code.

10. The method of servicing requests of claim 9 further comprising a method to service requests through the Web Agent which receives the request for financial information and determines the best method to access the required data and returns the appropriate response to the requesting client.

11. The method of claim 9 determining one method of retrieving requested data through access of the consumer's financial account data from the online financial Internet application's web pages. This method of data access further comprising a request to the Browser Proxy to login through a secure session on behalf of the consumer and access the consumer's online financial application's web pages, followed by a request to the HTML parser to extract relevant data from these web pages or application download files, normalize data, and return the data to the requester.

12. The method of claim 9 determining one method of retrieving requested data through extraction of previously collected consumer account data stored in the database. The manner of previous collection comprising a request to the Browser Proxy to login through a secure session on behalf of the consumer and access the consumer's online financial application's web pages, followed by a request to the HTML parser to extract relevant data from these web pages or application download files, normalize data, and insert the data into the database.

13. The method of the consumer's financial account data storage of claim 9 comprising temporary storage of collected account data in memory.

14. The method of the consumer's financial account data storage of claim 9 comprising storage of collected account data in a database. The account data in the database furthermore inserted through one of the following methods:

15. In response to a request from the Personal Financial Manager client for financial account data for a specific consumer

16. In response to a request from a program that is scheduled at regular interval and requests a refresh of data for some or all consumers enrolled into the service

17. The method of claim 9 accessing the consumer's personal financial data through use of encrypted access credentials passed in the request and only contained in memory for the duration of the session.

18. The method of claim 9 accessing the consumer's personal financial data through use of encrypted access credentials stored in the database from a previous enrollment, credentials update or data request
